(19) United States
(12) Patent Application Publication
(10) Pub. No.: US 2009/0187554 A1
(43) Pub. Date: Jul. 23, 2009

(54) SPECIFYING WEIGHTED SEARCH TERMS FOR A SEARCH ENGINE

(75) Inventors: Casey Dugan, Medford, MA (US); Michael Muller, Medford, MA (US); Jerry W. Redman, Cedar Park, TX (US); Amy D. Travis, Arlington, MA (US); Sara Weber, Arlington, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/017,059

(22) Filed: Jan. 21, 2008

(51) Int. Cl. G06F 17/30

(52) U.S. Cl. 707/5; 707/E17.108

(57) ABSTRACT

A content searching data processing system can be configured for specifying weighted search terms for a search engine. The system can include a search engine executing in a host server. The search engine can be coupled to a search index and can be configured for communicative coupling to different content browsers executing in respective clients over a computer communications network. Finally, the system can include weighted search term logic coupled to the search engine. The logic can include program code enabled to render a search term entry user interface in which variable weights are specified for corresponding search terms, to assign the variable weights to the corresponding search terms and to issue a search to the search engine with the search terms and variable weights and to return results of the search to a requesting one of the content browsers.

### BACKGROUND OF THE INVENTION

1. Field of the Invention

The present invention relates to the field of content searching and more particularly to specifying a content search according to multiple different search terms.

2. Description of the Related Art

Content browsing refers to the retrieval and presentation of electronic content in a browser client. Content generally can include electronic documents, messages, audio, audiovisual and video materials and imagery. Most commonly, content can be stored in a server environment and published for access by content consumers over a computer communications network such as the global Internet. Content consumers, in turn, can retrieve content over the network by reference to a network address for the content. Once retrieved, the content can be presented in a browser client including not only conventional visual browsers such as the venerable Web browser, but also in alternative browsers such as those deployed in pervasive devices and those supporting different modes of presentation such as the audible presentation of material.

Given the vast amount of content published for accessibility over the Internet, one cannot enjoy an awareness of a possible content of interest available for access over the Internet. Search engines fill the gap by providing an interface through which end users can instruct searches for documents according to one or more search terms. Basic search engines permit simple term searches where the presence of one or more search terms in content result in the return of a reference to the located content. More sophisticated search engines permit boolean searching and even more sophisticated search engines allow for natural language searching.

Where search terms are provided in a search engine, the results often reflect the relevance of a “hit” based upon a percentage of search terms present in the located content. Yet, in many cases, the search terms provided are not intended to be located in desired content. Rather, search engines frequently permit one to require the omission of any content containing a search term. In boolean terms, the NOT operation is permitted as well as the AND and OR operations. In any event, limiting the end user to providing search terms on an absolute basis of either “is present” or “is absent” reflects the reality that users in many cases lack a familiarity of particular search domain as most searches are ad hoc in nature.

Even still, from time to time users enjoy a substantial understanding of a search domain. In consequence, limiting such users to absolutes can be counterproductive. For example, when searching for content including terms A, B and C, but not D, one may recognize that in the search domain of interest, relevant content must include term A, and may include terms B and C, but should more often than not include term B in respect to term C. Further, relevant content should not include term D usually, but once in a while relevant content may include term D. Conventional search engines cannot support this type of search as a term is either included or excluded in relevant content from the perspective of the conventional search engine. Notwithstanding it would desirable to permit such users to emphasize the importance of one search term over another.

### BRIEF SUMMARY OF THE INVENTION

Embodiments of the present invention address deficiencies of the art in respect to content searching and provide a novel and non-obvious method, system and computer program product for specifying weighted search terms for a search engine. In an embodiment of the invention, a content searching data processing system can be configured for specifying weighted search terms for a search engine. The system can include a search engine executing in a host server. The search engine can be coupled to a search index and can be configured for communicative coupling to different content browsers executing in respective clients over a computer communications network. Finally, the system can include weighted search term logic coupled to the search engine. The logic can include program code enabled to assign variable weights to corresponding search terms and to issue a search to the search engine with the search terms and variable weights and to return results of the search to a requesting one of the content browsers.

In one aspect of the embodiment, the program code of the weighted search term logic further can be enabled to render a search term entry user interface in which the variable weights are specified for corresponding ones of the search terms. For instance, the search term user interface can include an iconic representation of each of the search terms, and a target comprising different portions for different variable weights, the target being configured for dragging-and-dropping of each iconic representation to assign a variable weight to a search term for each iconic representation. For instance, the different portions for different variable weights, can include different portions for different variable weights ranging from strongly exclusive (−1.0) to strongly inclusive (1.0).

As another example, the search term user interface can include a table listing each search term and in which a variable weight is specified manually in the table for each search term. As yet another example, the search term user interface can include a table in which a search term with a corresponding variable weight is specified manually in the table for each search term. As even yet another example, the search term user interface can include a table listing each search term and in which a variable weight is specified by way of a slider control in the table for each search term. As an additional example, the search term user interface can include a table listing each search term and in which a variable weight is specified by way of a slider control in the table responsive to a context menu selection for each search term. As yet a further example, the search term user interface can provide a text field into which each search term can be specified, and further into which a suffix can be provided to each search term to indicate a degree of relevance of the search term.

In another embodiment of the invention, a method for specifying weighted search terms for a search engine can be provided. The method can include assigning variable weights to corresponding search terms for a content search to be conducted by a search engine. The method further can include issuing a search to a search engine with the search terms and assigned variable weights. Even yet further, the method can include returning results of the search to a requesting content browser. In one aspect of the embodiment, assigning variable weights to corresponding search terms for a content search to be conducted by a search engine, can include rendering a search term entry user interface to receive the assignment of the variable weights.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A through 1E, taken together, are a pictorial illustration of a search term entry user interface configured for specifying weighted search terms for a search engine;

FIG. 2 is a schematic illustration of a content searching data processing system configured for specifying weighted search terms for a search engine; and,

FIG. 3 is a flow chart illustrating a process for specifying weighted search terms for a search engine.

### DETAILED DESCRIPTION OF THE INVENTION

Embodiments of the present invention provide a method, system and computer program product for specifying weighted search terms for a search engine. In accordance with an embodiment of the present invention, different search terms can be specified for a search of content. The search terms can be both inclusive and exclusive in that some terms are to be present in located content and other terms are to be absent from located content in order to satisfy the search. The presence of the search terms, however, need not be absolute and can be variable in nature. In this regard, a variable weight can be applied to one or more of the search terms such that while it may be preferred that the search term is present or absent from located content, as the case may be, it is not required and depending upon the presence or absence of other search terms of more significant weight, located content containing or excluding specified search terms can be returned as part of search results for the search.

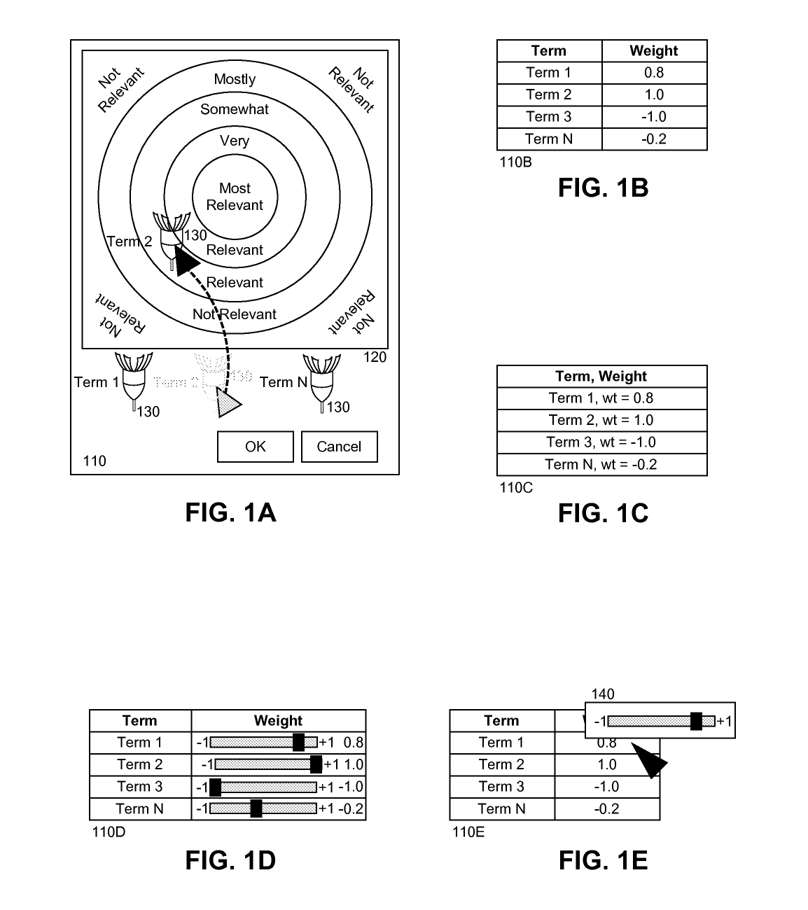

The variable weights for the search terms can be specified through a search term entry interface. By way of example, FIGS. 1A through 1E, taken together, are a pictorial illustration of a search term entry user interface configured for specifying weighted search terms for a search engine. Referring initially to FIG. 1A, a search term entry user interface 110A can include multiple different iconic representations 130 of different specified search terms. A target 120 further can be provided with concentric rings, each corresponding to a relative weight.

The relative weights shown in the target 120 can range from not relevant (0.0 value) to most relevant (1.0) value. Alternatively, the relative weights shown in the target 120 can range from strongly exclusive (−1.0 value) to not relevant (0.0) to strongly inclusive (1.0) value. In this regard, a value of +1 can represent extreme inclusion, meaning that, on the basis of this search term, the content associated with this search term has the highest likelihood of being returned as part of the search results. Conversely, a value of −1 represent extreme exclusion, meaning that, on the basis of this search term, the content associated with this search term has the lowest likelihood of being returned as part of the search results. In practice, the determination of whether a particular content appears in the search results depends on the combination of search terms and their weights. In any event, each iconic representation 130 of a search term can be dragged and dropped onto a portion of the target 120. The placement of the iconic representation 130 can result in an assignment of an associated variable weight to an underlying search term. In this way, the variable weights for each search term can be applied intuitively in a familiar graphical user interface.

FIG. 1B demonstrates a simplified form of a search term entry user interface 110B in which search terms can be listed in a table and variable weights can be applied to corresponding search terms in the table. As shown in FIG. 1C, in an even more simplified form, a search term entry user interface 110C can be provided where an end user directly states the assignment of variable weights to corresponding search terms. As shown in FIG. 1D, a slider control can be provided in lieu of a textual field for entering variable weights for corresponding search terms in a search term entry user interface 110D. As shown in FIG. 1E, a slider control can be provided in a pop up 140 for a selected search term, for example in response to a selection of a menu choice in a context menu for the selected search term in a search term entry user interface 110E. Finally, a text-only search term entry user interface can be provided into which a user can specify a series of search terms, each with a suffix to denote the relevance. For example, the suffix can take the form of symbols, for example “term+++” for “highly relevant,” “term++” for “very relevant,” and “term+” for “somewhat relevant.” As another example, the suffix can take the form of quantitative search weight expressions, for example “term(.45)”.

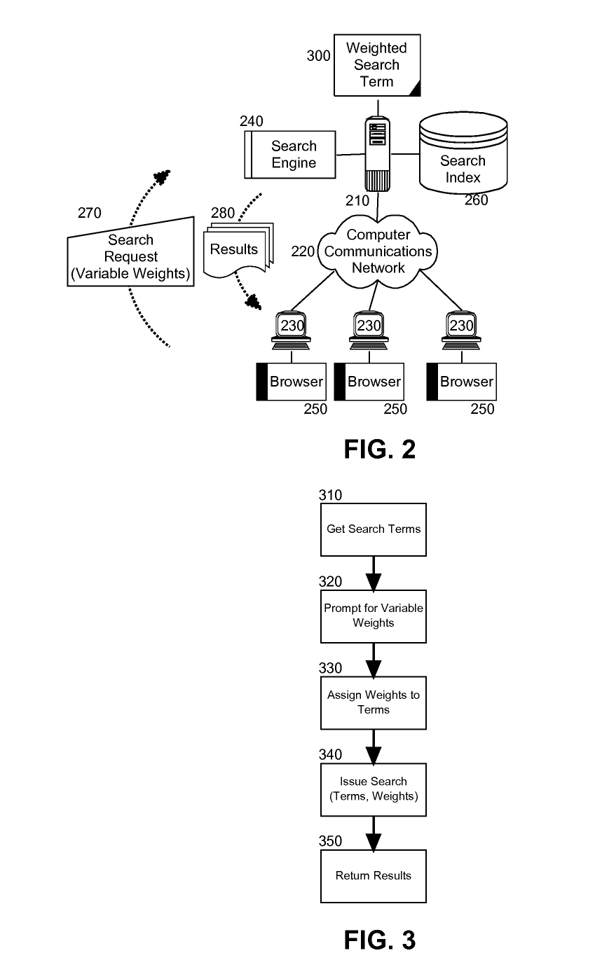

The search term user interface 110A, 110B, 110C, 110D, 110E shown in FIG. 1A through 1E can be generated and managed within a content searching data processing system. In illustration, FIG. 2 schematically shows a content searching data processing system configured for specifying weighted search terms for a search engine. The system can include a host server 210 configured for communicative coupling to multiple different clients 230 over computer communications network 220. The host server 210 can support the execution of a search engine 240 configured to provide search results 280 for rendering in content browsers 250 in response to receiving search requests 70 based upon a search index 260 coupled to the search engine 240 via host server 210.

Notably, weighted search term logic 300 can be coupled to the search engine 240 by way of host server 210. The search term logic 300 can include program code enabled to prompt an end user through a respective content browsers 250 for variable weights specified in a search request 270. The prompt can be provided within a search term entry user interface. Once received, the search index 260 can be searched for results in accordance with the provided search terms and the corresponding weights. Subsequently, the search results 280 can be returned to the end user for rendering in the respective content browser 250 from whence the request 270 originated.

In further illustration of the operation of the weighted search term logic 300, FIG. 3 is a flow chart illustrating a process for specifying weighted search terms for a search engine. The process can begin in block 310, with the receipt of search terms. In block 320, a prompt can be provided to specify variable weights for each of the search terms. In block 330, different variable weights can be assigned to specified ones of the search terms. Thereafter, in block 340 a search can be requested of a search engine with the search terms and the variable weights. Finally, in block 350 results for the search can be returned to the requester of the search.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A content searching data processing system configured for specifying weighted search terms for a search engine, the system comprising:
a search engine executing in a host server and being coupled to a search index and being configured for communicative coupling to different content browsers executing in respective clients over a computer communications network; and,
weighted search term logic coupled to the search engine, the logic comprising program code enabled to render a search term entry user interface in which variable weights are specified for corresponding search terms, to assign the variable weights to the corresponding search terms, and to issue a search to the search engine with the search terms and variable weights and to return results of the search to a requesting one of the content browsers.

2. The system of claim 1, wherein the search term user interface comprises:
an iconic representation of each of the search terms; and,
a target comprising different portions for different variable weights, the target being configured for dragging-and-dropping of each iconic representation to assign a variable weight to a search term for each iconic representation.

3. The system of claim 1, wherein the search term user interface comprises a table listing each search term and in which a variable weight is specified manually in the table for each search term.

4. The system of claim 1, wherein the search term user interface comprises a table in which a search term and a corresponding variable weight is specified manually in the table for each search term.

5. The system of claim 1, wherein the search term user interface comprises a table listing each search term and in which a variable weight is specified by way of a slider control in the table for each search term.

6. The system of claim 1, wherein the search term user interface comprises a table listing each search term and in which a variable weight is specified by way of a slider control in the table responsive to a context menu selection for each search term.

7. The system of claim 1, wherein the search term user interface comprises a data-entry field through which the relevance for each search term is specified as a corresponding suffix.

8. The system of claim 2, wherein the different portions for different variable weights, comprises different portions for different variable weights ranging from inversely relevant (−1.0) to most relevant (1.0).

9. A method for specifying weighted search terms for a search engine, the method comprising:
rendering a search term entry user interface to receive an assignment of the variable weights;
assigning variable weights received through the search term entry user interface to corresponding search terms for a content search to be conducted by a search engine;
issuing a search to a search engine with the search terms and assigned variable weights; and,
returning results of the search to a requesting content browser.

10. A computer program product comprising a computer usable medium embodying computer usable program code for specifying weighted search terms for a search engine, the computer program product comprising:
computer usable program code for rendering a search term entry user interface to receive an assignment of the variable weights;
computer usable program code for assigning variable weights received through the search term entry user interface to corresponding search terms for a content search to be conducted by a search engine;
computer usable program code for issuing a search to a search engine with the search terms and assigned variable weights; and,
computer usable program code for returning results of the search to a requesting content browser.
